(19) United States
(12) Patent Application Publication
(10) Pub. No.: US 2012/0258359 A1
(43) Pub. Date: Oct. 11, 2012

(54) METHOD FOR PRODUCING ELECTRODE, METHOD FOR PRODUCING ELECTRODE PASTE, AND SODIUM SECONDARY BATTERY

(75) Inventor: Maiko Saka, Tsukuba-shi (JP)

(73) Assignee: Sumitomo Chemical Company, Limited, Chuo-ku, Tokyo (JP)

(21) Appl. No.: 13/517,072

(22) PCT Filed: Dec. 15, 2010
(86) PCT No.: PCT/JP2010/073063

§ 371 Date: Jun. 19, 2012

(30) Foreign Application Priority Data
Dec. 24, 2009 (JP) 2009-292265

(51) Int. Cl. H01M 4/04; H01M 4/64

(52) U.S. Cl. 429/211; 427/58; 427/126.1; 252/182.1; 252/518.1

(57) ABSTRACT

The present invention provides a method for producing an electrode and a method for producing an electrode paste, and a sodium secondary battery. The method for producing an electrode includes the following steps (1) to (5) in this order:
(1) a step of bringing a raw material of P (phosphorus), a raw material of A (wherein A represents one or more elements selected from the group consisting of alkali metal elements and A comprises Na), a raw material of M (wherein M represents one or more elements selected from the group consisting of transition metal elements), and water into contact with each other and generating a liquid-like material thereby,
(2) a step of heating the liquid-like material and generating a precipitate of an electrode active material thereby, and then collecting the precipitate by solid-liquid separation,
(3) a step of mixing the collected precipitate and a binder and producing an electrode paste thereby,
(4) a step of applying the electrode paste on a current collector and forming an applied film thereby, and
(5) a step of drying the applied film and producing an electrode thereby.
   The sodium secondary battery has the electrode produced by the method as a positive electrode. The method for producing the electrode paste includes the following steps (11) to (13) in this order:
(11) a step of bringing a raw material of P (phosphorus), a raw material of A (wherein A represents one or more elements selected from the group consisting of alkali metal elements and A comprises Na), a raw material of M (wherein M represents one or more elements selected from the group consisting of transition metal elements), and water into contact with each other and generating a liquid-like material thereby,
(12) a step of heating the liquid-like material and generating a precipitate of an electrode active material thereby, and then collecting the precipitate by solid-liquid separation, and
(13) a step of mixing the collected precipitate and a binder and producing an electrode paste thereby.

### TECHNICAL FIELD

The present invention relates to a method for producing an electrode, a method for producing an electrode paste and a sodium secondary battery, and more specifically, the present invention relates to a method for producing an electrode effectively used for a sodium secondary battery and a method for producing an electrode paste.

### BACKGROUND ART

A lithium secondary battery has already been put into practical use as a power supply for use in small-sized apparatuses such as portable telephones and notebook personal computers. There have been increasing demands for a secondary battery as a power supply for use in large-sized apparatuses such as electric automobiles and dispersion-type power storages.

As an electrode active material for use in a positive electrode of a lithium secondary battery, transition metal lithium phosphate represented by LiMPO₄ (wherein M is at least one metal selected from transition metals) has been known. Patent Documents 1 and 2 have disclosed a technique in which, a paste is produced using transition metal lithium phosphate obtained by hydrothermal synthesis, an electrode is manufactured using the paste, and then a lithium secondary battery is produced using the electrode as a positive electrode.

### PRIOR ART DOCUMENT

### Patent Documents

[Patent Document 1]: JP2009-81072A
[Patent Document 2]: JP2006-261060A

### SUMMARY OF THE INVENTION

However, it cannot be said that Li to be used for an electrode of a lithium secondary battery is abundant as resources, and there is a fear of depletion of the Li resources in the future. Moreover, the above-mentioned hydrothermal synthesis usually requires a high-pressure condition of 1 MPa or more and causes greater costs for manufacturing facilities.

On the other hand, Na, which belongs to the same alkali metal elements as Li, is abundant in resources in comparison with Li resources, and is more inexpensive by one digit than Li. If a sodium secondary battery using Na can be utilized, a large number of large-sized secondary batteries, such as secondary batteries for mounting in automobiles and secondary batteries for dispersion-type power storages, can be produced, with suppression of a fear of depletion of the resources.

An object of the present invention is to provide a method for easily producing an electrode and an electrode paste using Na, and a sodium secondary battery using such an electrode.

The present invention provides the following means:

<1> A method for producing an electrode comprising the following steps of (1) to (5) in this order:
(1) a step of bringing a raw material of P (phosphorus), a raw material of A (wherein A represents one or more elements selected from the group consisting of alkali metal elements and A comprises Na), a raw material of M (wherein M represents one or more elements selected from the group consisting of transition metal elements), and water into contact with each other and generating a liquid-like material thereby,
(2) a step of heating the liquid-like material and generating a precipitate of an electrode active material thereby, and then collecting the precipitate by solid-liquid separation,
(3) a step of mixing the collected precipitate and a binder and producing an electrode paste thereby,
(4) a step of applying the electrode paste on a current collector and forming an applied film thereby, and
(5) a step of drying the applied film and producing an electrode thereby.
<2> The method according to <1>, wherein the heating in the step (2) is performed under the pressure of from 0.01 MPa to 0.5 MPa.
<3> The method according to <1> or <2>, wherein any one of steps (1) to (3) further comprises mixing of an electrical conductive material.
<4> The method according to any one of <1> to <3>, wherein the step (3) further comprises mixing of a viscosity improver.
<5> The method according to any one of <1> to <4>, wherein the electrode active material is represented by the following formula (I):

AMPO₄ (I)

wherein A and M each have the same meaning as defined above.
<6> The method according to any one of <1> to <5>, wherein M comprises a divalent transition metal element.
<7> The method according to any one of <1> to <6>, wherein M comprises Fe or Mn or both.
<8> The method according to any one of <1> to <7>, wherein A is Na.
<9> The method according to any one of <1> to <8>, wherein the binder is an aqueous binder.
<10> The method according to <4>, wherein the viscosity improver is an aqueous viscosity improver.
<11> A sodium secondary battery comprising an electrode produced by the method according to any one of <1> to <10> as a positive electrode.
<12> A method for producing an electrode paste comprising the following steps (11) to (13) in this order:
(11) a step of bringing a raw material of P (phosphorus), a raw material of A (wherein A represents one or more elements selected from the group consisting of alkali metal elements and A comprises Na), a raw material of M (wherein M represents one or more elements selected from the group consisting of transition metal elements), and water into contact with each other and generating a liquid-like material thereby,
(12) a step of heating the liquid-like material and generating a precipitate of an electrode active material thereby, and then collecting the precipitate by solid-liquid separation, and
(13) a step of mixing the collected precipitate and a binder and producing an electrode paste thereby.
<13> The method according to <12>, wherein any one of steps (11) to (13) further comprises mixing of an electrical conductive material.
<14> The method according to <12> or <13>, wherein the step (13) further comprises mixing of an aqueous viscosity improver.
<15> An electrode paste produced by the method according to any one of <12> to <14>.

### BRIEF DESCRIPTION OF THE DRAWING

FIG. 1 shows a relationship between the number of cycles and a discharging capacity retaining rate in a sodium secondary battery in accordance with the present invention.

### MODE FOR CARRYING OUT THE INVENTION

### Method for Producing Electrode

The method for producing an electrode includes the following steps (1) to (5) in this order.

The step (1) is a step of bringing a raw material of P (phosphorus), a raw material of A (wherein A represents one or more elements selected from the group consisting of alkali metal elements and A includes Na), a raw material of M (wherein M represents one or more elements selected from the group consisting of transition metal elements), and water into contact with each other and generating a liquid-like material thereby.

The step (2) is a step of heating the liquid-like material and generating a precipitate of an electrode active material thereby, and then collecting the precipitate by solid-liquid separation.

The step (3) is a step of mixing the collected precipitate and a binder and producing an electrode paste thereby.

The step (4) is a step of applying the electrode paste on a current collector and forming an applied film thereby.

The step (5) is a step of drying the applied film and producing an electrode thereby.

The raw material of P (phosphorus), the raw material of A (wherein A represents one or more elements selected from the group consisting of alkali metal elements and A also includes Na) and the raw material of M (wherein M represents one or more elements selected from the group consisting of transition metal elements) may be a compound of P (hereinafter, referred to also as “P compound”), a compound of A (hereinafter, referred to also as “A compound”) and a compound of M (hereinafter, referred to also as “M compound”) respectively, or may be a simple substance of P, a simple substance of each of A and a simple substance of each of M. The liquid-like material may be an aqueous solution in which a solute is completely dissolved or a solid-liquid mixture containing a solid-state component deposited by the contact.

In the step (1), for example, by bringing the P compound, the A compound, the M compound and water into contact with each other, a liquid-like material is obtained. In place of the P compound and the A compound, a mixed compound containing P and A may be used, in place of the P compound and the M compound, a mixed compound containing P and M may be used, and in place of the A compound and the M compound, a mixed compound containing A and M may be used. Examples of the mixed compound containing P and A include AH₂PO₄, A₂HPO₄, and A₃PO₄, and examples of the mixed compound containing P and M include phosphates of M (for example, iron phosphate, and manganese phosphate). Examples of the mixed compound containing A and M include AMO₂.

As the raw material of P, a P compound is preferably used. Moreover, a simple substance of P, such as black phosphorus, may be used. Examples of the P compound include oxides such as P₂O₅ and P₄O₆, halides such as PCl₅, PF₅, PBr₅ and PI₅, oxyhalides such as POF₃, POCl₃ and POF₃, ammonium salts such as (NH₄)₂HPO₄ and (NH₄) H₂PO₄, and phosphates such as H₃PO₄. In the step (1), from the viewpoint of improving the reactivity with the raw material of A, the raw material of M, or both, the P compound is preferably used as an aqueous solution (hereinafter, referred to also as “aqueous solution of P compound”) obtained by dissolving the P compound in water.

In the case where an ammonium salt of P is used as the P compound, the ammonium salt is dissolved in water, and an aqueous solution of the P compound may be produced. In the case where the P compound is hardly dissolved in water, for example, in the case where the P compound is an oxide or the like, the P compound is dissolved in an acidic aqueous solution of an inorganic acid such as hydrochloric acid, sulfuric acid, or nitric acid, or of an organic acid such as acetic acid, so that an aqueous solution of the P compound may be produced. Among the above-mentioned P compounds, two kinds or more thereof may be used in combination. From the viewpoint of obtaining an aqueous solution of the P compound by using a simple method in the step (1), the P compound is preferably phosphoric acid or an ammonium salt or both, and from the viewpoint of obtaining an electrode active material having high purity, in particular, phosphoric acid is preferable.

As the raw material of A, an A compound is preferably used. A simple substance of A (metal) may be used. Examples of the alkali metal element A include Li, Na, and K, and Na is preferably used as the raw material of A. Examples of the A compound include compounds of alkali metal elements such as Li, Na and K, that is, oxides, hydroxides, halides, nitrates, sulfates, carbonates, oxalates, and acetates thereof. The following description will specifically discuss Na compounds in which Na is used as A; however, the description is not limited thereto, compounds of other alkali metal elements may be included. Examples of the Na compounds include oxides such as Na₂O and Na₂O₂, hydroxides such as NaOH, halides such as NaCl and NaF, nitrates such as NaNO₃, sulfates such as Na₂SO₄, carbonates such as Na₂CO₃ and NaHCO₃, oxalates such as Na₂C₂O₄, and acetates such as Na(CH₃COO). In the step (1), from the viewpoint of improving the reactivity with the raw material of P, the raw material of M, or both, the A compound is preferably used as an aqueous solution (hereinafter, referred to also as “aqueous solution of A compound”) obtained by dissolving the A compound in water.

In the case where, for example, a water-soluble compound of an oxide, a hydroxide, a halide or the like is used as the A compound, the compound is dissolved in water so that an aqueous solution of the A compound may be produced. In general, most of the A compounds are easily dissolved in water; however, in the case of a compound that is difficult to be dissolved, the compound may be dissolved in an acidic aqueous solution of an inorganic acid such as hydrochloric acid, sulfuric acid, nitric acid or the like, or of an organic acid such as acetic acid, so that an aqueous solution of the A compound may be produced. Among the above-mentioned A compounds, two or more kinds thereof may be used in combination. From the viewpoint of obtaining an aqueous solution of the A compound by using a simple method in the step (1), the A compound is preferably a hydroxide or a halide such as a chloride or both of a hydroxide and a chloride, and from the viewpoint of preferably allowing an aqueous solution of the A compound to have an alkaline property, the A compound is preferably a hydroxide.

As the raw material of M, an M compound is preferably used. A simple substance of M (metal M) may be used. Examples of the transition metal element M include Ti, V, Cr, Mn, Fe, Co, Ni, and Cu. In the case where an electrode produced by the method of the present invention is used as a positive electrode, M is preferably a divalent transition metal element, from the viewpoint of obtaining a secondary battery having high capacity. It is preferable to allow M to contain Fe or Mn or both, and in particular, it is preferable that M be Fe or Mn or both.

Examples of the M compound include oxides such as MO, MO₂, MO₂O₃ and MO₄, hydroxides such as M(OH)₂ and M(OH)₃, oxyhydroxides such as MOOR, halides such as MF₂, MF₃, MCl₂, MCl₃, MI₂ and MI₃, nitrates such as M(NO₃)₂ and M(NO₃)₃, sulfates such as M(SO₄) and M₂(SO₄)₃, carbonates such as MCO₃, oxalates such as MC₂O₄, acetates such as M(CH₃COO)₂ and M(CH₃COO)₃, formates such as M(HCOO)₂, propionates such as M(C₂H₅COO)₂, malonates such as M(CH₂(COO)₂), and succinates such as M(C₂H₄COO)₂). In the step (1), from the viewpoint of improving the reactivity with the raw material of P, or the raw material of Na, or both, the M compound is preferably used as an aqueous solution (hereinafter, referred to also as “aqueous solution of M compound”) obtained by dissolving the M compound in water.

In the case where, a water-soluble compound of a halide, a nitrate, a sulfate, an oxalate, an acetate or the like is used as the M compound, the compound is dissolved in water so that an aqueous solution of the M compound may be prepared. In the case where the M compound is hardly dissolved in water, for example, in the case where the M compound is an oxide, a hydroxide, an oxyhydroxide, a carbonate, or the like, the compound may be dissolved in an acidic aqueous solution of an inorganic acid such as hydrochloric acid, sulfuric acid, or nitric acid, or of an organic acid such as acetic acid, so that an aqueous solution of the M compound may be produced. Among the above-mentioned M compounds, two or more kinds thereof may be used in combination. From the viewpoint of obtaining an aqueous solution of the M compound by using a simple method in the step (1), the M compound is preferably a halide, and particularly preferably a chloride of M. In order to stably maintain M, such as Fe and Mn, as a divalent group in the aqueous solution of the M compound, a reducer is preferably contained in the aqueous solution. Examples of the reducer include ascorbic acid, oxalic acid, zinc chloride, potassium iodide, sulfur dioxide, hydrogen peroxide, and aniline, and ascorbic acid or aniline is preferable, and ascorbic acid is more preferable.

In the step (1), an aqueous solution containing P and A and an aqueous solution containing the M compound are brought into contact with each other so that a liquid-like material can be generated. As the aqueous solution containing P and A, among simple substances of P and A, and the P compounds and the A compounds, any compounds may be selected, and dissolved in water to produce the aqueous solution. In this case, the aqueous solution containing P and A may be an aqueous solution formed by bringing a mixed compound containing P and A into contact with water.

In the step (1), an aqueous solution containing A and M and an aqueous solution containing P are also brought into contact with each other so that a liquid-like material can be generated. As the aqueous solution containing A and M, among simple substances of A and M, and the A compounds and the M compounds, any compounds may be selected, and dissolved in water to produce the aqueous solution. In this case, the aqueous solution containing A and M may be an aqueous solution formed by bringing a mixed compound containing A and M into contact with water.

In the step (1), an aqueous solution of the P compound, an aqueous solution of the Na compound and an aqueous solution of the M compound may be brought into contact with each other so that a liquid-like material can be generated. As the aqueous solution of the P compound, the aqueous solution of the Na compound and the aqueous solution of the M compound, required compounds are respectively selected arbitrarily, and dissolved in water so that each of the aqueous solutions of the compounds may be produced.

From the viewpoint of obtaining a liquid-like material in which the P compound, the Na compound and the M compound are uniformly reacted with each other, the P compound, the Na compound and the M compound are preferably used as aqueous solutions containing the respective compounds, and in particular, the M compound is preferably used as an aqueous solution thereof. Within a range not impairing the object of the present invention, the liquid-like material may contain components other than P, Na, M and water.

In the step of generating the liquid-like material, any mixing method may be used. Examples of the mixing device include a stirring mixer using a stirrer, a stirring mixer using a stirring blade, a V-type mixer, a W-type mixer, a ribbon mixer, a drum mixer, and a ball mill.

Within a range that allows the resultant sodium secondary battery to be used as a secondary battery, a substance containing elements other than A, P, and M may be added to the liquid-like material, with one portion of A, P and M in the transition metal phosphate being substituted with other elements. Examples of the other elements include elements such as B, C, N, F, Mg, Al, Si, S, Cl, Ca, Ga, Ge, Rb, Sr, In, Sn, I and Ba.

In an attempt to increase the discharging capacity of the resultant secondary battery, the electrode active material of the present invention is preferably represented by the formula (I):

AMPO₄ (I)

wherein A and M each have the same meaning as defined above.

In the present invention, M represents one or more elements selected from the group of transition metal elements, and examples of the transition metal element M include Ti, V, Cr, Mn, Fe, Co, Ni and Cu. In an attempt to further increase the discharging capacity of the resultant sodium secondary battery, M is preferably a transition metal element that can form a divalent group. Moreover, from the viewpoint of obtaining a secondary battery that has high capacity and is inexpensive, M preferably contains Fe or Mn or both, and is more preferably M or F or both.

In the step (2) in the present invention, the liquid-like material is heated. By heating the material, reactions among the raw material of P, the raw material of Na and the raw material of M can be accelerated so that a precipitate of an electrode active material can be obtained. The temperature range of the heating is preferably from 40° C. to 200° C., more preferably from 80° C. to 190° C., and further preferably from 90° C. to 180° C. The liquid-state material is preferably heated while being mixed by stirring or the like; thus, it improves the reaction accelerating effect by the heating.

Examples of the atmosphere at the time of heating the liquid-like material in the step (2) include, but are not particularly limited to, an oxidizing atmosphere containing oxygen such as the atmospheric air, an inert gas atmosphere containing nitrogen or argon, and a reducing atmosphere containing hydrogen. Oxygen and nitrogen, oxygen and argon, or the like may be mixed appropriately so as to adjust the reducing atmosphere. The simple atmospheric air is preferably used. In the present invention, the heating is preferably performed under the pressure of from 0.01 MPa to 0.5 MPa, and more preferably from 0.05 MPa to 0.2 MPa. In the present invention, no high-pressure condition of 1 MPa or higher is required.

In the step (2), after the precipitate of an electrode active material is generated by heating, the precipitate of an electrode active material is collected by solid-liquid separation. The method of the solid-liquid separation is not particularly limited; however filtration is preferably used. The precipitate of an electrode active material, collected in the step (2), may be washed, and a solvent to be used for the washing is preferably water. Preferable water is pure water or ion-exchange water or both. By performing the washing, impurities such as water-soluble impurities in the precipitate of an electrode active material can be reduced. In the collected precipitate of an electrode active material, the amount of moisture relative to the total weight of the precipitate is preferably about 1 to 60% by weight, more preferably about 30 to 50% by weight.

Examples of the atmosphere at the time of solid-liquid separation in the step (2) include, but are not particularly limited to, an oxidizing atmosphere containing oxygen such as the atmospheric air, an inert gas atmosphere containing nitrogen or argon, and a reducing atmosphere containing hydrogen. The precipitate of an electrode active material can be easily collected in the atmospheric air.

The following description will discuss more specific examples of the steps (1) and (2). For example, in the case where a precipitate of an electrode active material of sodium iron phosphate represented by NaFePO₄, which is one of preferable compositions, is collected, first, sodium hydroxide, a ferric chloride (II) tetrahydrate and diammonium hydrogenphosphate are precisely weighed so as to have a molar ratio of Na:Fe:P of 4:1:1. In this case, an excessive amount of Na is used. Next, the respective compounds thus precisely weighed are dissolved in ion-exchange water to prepare aqueous solutions of the respective compounds, and the respective aqueous solutions are brought into contact with each other so that a liquid-like material is generated. By heating the liquid-like material, a precipitate of an electrode active material is generated, and by solid-liquid separation, the precipitate of an electrode active material is collected.

In the case where a precipitate of an electrode active material of sodium manganese phosphate represented by NaMnPO₄, which is one of preferable compositions, is collected, first, sodium hydroxide, a manganese chloride (II) hexahydrate and phosphoric acid are precisely weighed so as to have a molar ratio of Na:Mn:P of 3:1:1. In this case, an excessive amount of Na is used. Next, the respective compounds thus precisely weighed are dissolved in ion-exchange water to prepare aqueous solutions of the respective compounds, and the respective aqueous solutions are brought into contact with each other so that a liquid-like material is generated. By heating the liquid-like material, a precipitate of an electrode active material is generated, and by solid-liquid separation, the precipitate of an electrode active material is collected.

In the case where a precipitate of an electrode active material of a sodium manganese-iron phosphate represented by NaMnₓFe₁₋ₓPO₄ is collected, first, sodium hydroxide, a manganese chloride (II) hexahydrate, a ferric chloride (II) tetrahydrate and phosphoric acid are precisely weighed so as to have a molar ratio of Na:Mn:Fe: P of 5:x:(1-x):1. In this case, an excessive amount of Na is used. Next, the respective compounds thus weighed are dissolved in ion-exchange water to prepare aqueous solutions of the respective compounds, and the respective aqueous solutions are brought into contact with each other so that a liquid-like material is generated. By heating the liquid-like material, a precipitate of an electrode active material is generated, and by solid-liquid separation, the precipitate of an electrode active material is collected.

In the step (3) of the present invention, the collected precipitate of the electrode active material and a binder are mixed so that an electrode paste is produced. As described earlier, in the precipitate of the electrode active material, the amount of moisture relative to the total weight of the precipitate is preferably about 1 to 60% by weight, and more preferably about 30 to 50% by weight.

Examples of the binder in the step (3) include a thermoplastic resin, a thermosetting resin, and an ionizing radiation curable resin. Examples of the thermosetting resin include a polyester resin, a polyamide resin, a polyimide resin, a polyacrylic ester resin, a polycarbonate resin, a polyurethane resin, a cellulose resin, a polyolefin resin, a polyvinyl resin, a fluorine-based resin, a polyimide resin, an alkyl resin, and NBR, and a plurality of these may be used in combination. As the binder, an aqueous binder is preferably used.

The aqueous binder contains binder particles including a resin and water serving as a dispersion medium for dispersing the particles. One portion of water (for example, less than 50% by weight of water) may be substituted with an organic solvent soluble in water. As the dispersion medium, only water is preferably used. The aqueous binder contains an aqueous emulsion or an aqueous dispersion or both.

Examples of the aqueous emulsion include one or more kinds of aqueous emulsions selected from the group consisting of vinyl-based polymer emulsions and acrylic polymer emulsions. Examples of the vinyl-based polymer include a vinyl acetate-based polymer (vinyl acetate homopolymer, vinyl acetate copolymer) and a vinyl chloride-based polymer (vinyl chloride homopolymer, vinyl chloride copolymer), and examples of the acrylic polymer include an alkyl acrylate homopolymer (methylacrylate polymer, ethylacrylate polymer, etc.) and an alkyl acrylate copolymer, and from the viewpoint of controllability of glass transition temperature, etc., among these polymers, copolymers are preferably used. More specific examples of the copolymer include an ethylene-vinyl acetate copolymer, an ethylene-vinyl acetate-vinyl chloride copolymer, a vinyl acetate-alkyl acrylate copolymer (vinyl acetate-methyl acrylate copolymer, vinyl acetate-ethyl acrylate copolymer, etc.), an ethylene-vinyl chloride copolymer, a vinyl chloride-vinyl acetate copolymer, a vinyl chloride-alkyl acrylate copolymer (vinyl chloride-methyl acrylate copolymer, vinyl chloride-ethyl acrylate copolymer, etc.), an ethylene-vinyl acetate-alkyl acrylate copolymer (ethylene-vinyl acetate-methyl acrylate copolymer, ethylene-vinyl acetate-ethyl acrylate copolymer, etc.), and a methyl acrylate-ethyl acrylate copolymer. Two or more kinds of these vinyl-based polymers may be mixed and used.

In the case where an aqueous emulsion is used as the aqueous binder, an electrode can be obtained which is superior in binding strength with a current collector to be described later and has superior peel strength. Thus, superior characteristics of a sodium secondary battery are ensured for a long period of time. The amount of the aqueous emulsion used may be a small amount, and this also effectively devotes to an improvement in energy density per volume of a sodium secondary battery, that is, an improvement in capacity.

The aqueous emulsion is produced, for example, by a surfactant method in which a surfactant such as soap is used and emulsion polymerization such as a colloid method in which a water-soluble polymer such as polyvinyl alcohol is used as a protection colloid. A batch polymerization method, a pre-emulsion dripping method, a monomer dripping method or the like may be used. By controlling the monomer concentration, reaction temperature, stirring rate and the like, the average particle diameter of the binder particles in the aqueous emulsion can be changed. By the emulsion polymerization, the particle size distribution of the binder particles can be made sharp, and by using the aqueous emulsion, various components of the electrode can be made uniform.

As the aqueous dispersion, any of known dispersions may be used, and a polytetrafluoroethylene-based aqueous dispersion is preferably used. For example, by dispersing polytetrafluoroethylene in water, an aqueous dispersion can be obtained.

Binder particles dispersed in an aqueous binder (for example, an aqueous emulsion or an aqueous dispersion) serve a function for binding the precipitate of an electrode active material and a current collector, as well as for binding these materials to an electrical conductive material to be described later. Therefore, it is preferable to uniformly disperse the aqueous binder in the electrode paste. In order to more uniformly disperse the binder particles in the electrode paste, the average particle diameter of the binder particles is preferably adjusted to 1 to 300% relative to the average particle diameter of the precipitate of an electrode active material. For example, when the average particle diameter of the precipitate of an electrode active material is in a range from 0.1 to 0.3 μm, the average particle diameter of the binder particles is preferably from 0.001 to 0.9 μm. In the present invention, the average particle diameter of the precipitate of an electrode active material can be determined through observations by an electron microscope such as SEM.

The content of the binder in the electrode paste is preferably 0.1 to 10 parts by weight, and more preferably 0.5 to 5 parts by weight, per 100 parts by weight of the precipitate of an electrode active material, from the viewpoints of improving the binding strength of the electrode paste to a current collector and of suppressing an increase in resistance of the resultant electrode.

In any one of the steps (1) to (3), pH adjustment is preferably performed. In this case, the pH adjustment is more preferably performed so as to set the pH of the electrode paste in the step (3) to about 7.

Any one of the steps (1) to (3) preferably further includes mixing of an electrical conductive material. A carbonaceous material may be used as the electrical conductive material, and examples thereof include a graphite powder, carbon black (for example, acetylene black), and a fiber-state carbonaceous material (for example, a carbon nanotube, a carbon nanofiber, and a vapor phase grown carbon fiber). Carbon black (for example, acetylene black) is in the form of fine particles with a large surface area. When a small amount of the material is contained in the electrode paste, the conductivity inside the resultant electrode becomes higher so that the charging/discharging efficiency and large-current discharging characteristics of a secondary battery can be improved. A preferable ratio of the electrical conductive material in the electrode paste is normally from 10 parts by weight to 30 parts by weight, per 100 parts by weight of the precipitate of an electrode active material. In the case where the above-mentioned carbonaceous material with fine particles or fiber-state carbonaceous material is used as the electrical conductive material, this ratio can be reduced. Supposing that the length of the fiber-state carbonaceous material is a, and that the diameter of a cross section of the material perpendicular to the length direction is b, the value of a/b is normally 20 to 1000. Supposing that the length of the fiber-state carbonaceous material is a, and that the average particle diameter (D50) on a volume basis of primary particles and aggregated particles of the primary particles is c in the precipitate of an electrode active material, the value of a/c is normally 2 to 100, and more preferably 2 to 50. It is preferable that the electric conductivity of the fiber-state carbonaceous material be higher. The electric conductivity of the fiber-state carbonaceous material is measured by using a sample prepared by molding the fiber-state carbonaceous material to have a density of from 1.0 to 1.5 g/cm³. The electric conductivity of the fiber-state carbonaceous material is normally 1 S/cm or more, and preferably 2 S/cm or more.

Specific examples of the fiber-state carbonaceous material include graphitized carbon fibers and carbon nanotubes. Either single-wall carbon nanotubes or multi-wall carbon nanotubes may be used as the carbon nanotubes. With respect to the fiber-state carbonaceous materials, those commercially available may be pulverized so as to be adjusted within the above-mentioned ranges of a/b and a/c. The pulverization may be either dry pulverization or wet pulverization, and examples of the dry pulverization apparatus include a ball mill, a rocking mill and a planetary ball mill, and examples of the wet pulverization apparatus include a ball mill and a disperser. Examples of the disperser include a Dispermat (product name, manufactured by Eko Instruments Co., Ltd.).

The step (3) in the present invention further preferably includes mixing of a viscosity improver. Examples of the viscosity improver include methylcellulose, carboxy methylcellulose (hereinafter, referred to also as “CMC”), polyethylene glycol, sodium polyacrylate, polyvinyl alcohol, polyvinyl pyrrolidone, hydroxyethyl cellulose, polyethylene oxide, and a carboxyvinyl polymer. Two or more kinds of these viscosity improvers may be mixed and used. Among these viscosity improvers, from the viewpoint of further improving the binding strength, aqueous viscosity improvers that are water-soluble are preferably used, and examples of the aqueous viscosity improver include methylcellulose, carboxymethyl cellulose, polyethylene glycol, sodium polyacrylate, polyvinyl alcohol, and polyvinyl pyrrolidone.

A preferable mixed ratio of the viscosity improver is preferably from 500 parts by weight to 1000 parts by weight per 100 parts by weight of the binder. By mixing the viscosity improver in this manner, the binding strength can be further enhanced. Moreover, the application property to a current collector is improved so that electrodes can be supplied more stably.

In the step (3), the collected precipitate of an electrode active material, the binder, and if necessary, the electrical conductive material and the viscosity improver are mixed with each other to produce the electrode paste. In the case where the electrical conductive material is mixed, as the order of the mixing, the precipitate of an electrode active material and the electrical conductive material are preliminarily mixed, and then the binder is added thereto so that the mixing may be performed.

As the mixer to be used for mixing, those having a high shearing force are preferably used. Specific examples thereof include a planetary mixer, a disper mixer, a beads mill, a kneader, a sand mill, a Henschel mixer, and an extrusion kneader. From the viewpoint of improving the dispersing property of various components in the electrode paste, an ultrasonic dispersing machine typically represented by a homogenizer can be used. Thus, aggregation of the various components in the electrode paste is alleviated so that a more homogeneous electrode paste can be produced.

At the time of mixing in the step (3), various solvents may be added if necessary. Examples of the solvents include amine-based solvents such as N,N-dimethyl aminopropyl amine and diethylene triamine, ether-based solvents such as tetrahydrofuran, ketone-based solvents such as methylethyl ketone, ester-based solvents such as methyl acetate, amide-based solvents such as dimethylacetoamide, and N-methyl-2-pyrrolidone, and water.

In the present invention, the concentration of the electrode components in the electrode paste, that is, the total weight ratio of the precipitate (converted on the assumption that no water is contained) of an electrode active material, the electrical conductive material, the binder and the viscosity improver, is normally 10 to 90% by weight, preferably 10 to 80% by weight, and more preferably 10 to 70% by weight relative to the electrode paste, from the viewpoints of the thickness of the resultant electrode and the application property thereof.

As described earlier, from the viewpoint of further enhancing the effects of the present invention, the method that uses an aqueous binder as the binder is a very effective method. The method for producing an electrode paste of the present invention includes the following steps (11) to (13) in this order:

(11) a step of bringing a raw material of P (phosphorus), a raw material of A (wherein A represents one or more elements selected from the group consisting of alkali metal elements and A comprises Na), a raw material of M (wherein M represents one or more elements selected from the group consisting of transition metal elements), and water into contact with each other and generating a liquid-like material thereby,
(12) a step of heating the liquid-like material and generating a precipitate of an electrode active material thereby, and then collecting the precipitate by solid-liquid separation, and
(13) a step of mixing the collected precipitate and a binder and producing an electrode paste thereby.

As described earlier, preferably, any one of the steps (11) to (13) further includes mixing of an electrical conductive material. Moreover, in the same manner as described earlier, the step (13) preferably further includes mixing of a viscosity improver, and the viscosity improver is preferably an aqueous viscosity improver.

In the step (4), by applying the electrode paste on a current collector, an applied film is formed thereon. In the case where the resultant electrode is used as a positive electrode for a secondary battery, examples of the current collector include Al, Ni, and stainless steel, and from the viewpoints of easiness in processing into thin film and low costs, Al is preferably used.

Examples of the method of applying the electrode paste on the current collector include a slit-die coating method, a screen coating method, a curtain coating method, a knife coating method, a gravure coating method, and an electrostatic spraying method. The application is preferably performed uniformly by using any of these methods. The applied weight is for example from 2 to 25 mg/cm², and more preferably from 5 to 20 mg/cm² in dry weight.

In the step (5), by drying the applied film thus formed, an electrode is produced. By drying the applied film, solvents such as moisture in the paste applied film are removed. The drying temperature range is preferably from 40° C. to 200° C., more preferably from 80° C. to 170° C., and still preferably from 90° C. to 160° C. After the drying, the electrode may be put under reduced pressure, or the electrode may be pressed by plate press or roller press.

### <Sodium Secondary Battery>

In the present invention, a sodium secondary battery has an electrode produced by the present invention. In particular, a sodium secondary battery, which has the electrode produced by the method of the present invention as a positive electrode, is sufficiently superior in secondary battery characteristics such as charging/discharging characteristics, and is effectively utilized.

The following description will discuss a method for producing a sodium secondary battery in which an electrode is used as a positive electrode. In the case where the sodium secondary battery has a separator, the sodium secondary battery can be produced through processes in which a group of electrodes, each obtained by stacking or stacking and winding a positive electrode, a separator, a negative electrode and a separator in this order, is housed in a battery case such as a battery can, and an electrolytic solution containing an electrolyte and being comprised of an organic solvent is injected into the case. In the case of a sodium secondary battery without a separator, the sodium secondary battery can be produced, for example, through processes in which a group of electrodes, each obtained by stacking or stacking and winding a positive electrode, a solid-state electrolyte, a negative electrode and a solid-state electrolyte in this order, is housed in a battery case such as a battery can.

Examples of the shape of the group of electrodes include shapes having a cross section such as a circular shape, an elliptical shape, a rectangular shape or a rectangular shape with round corners, when the group of electrodes was cut in the direction perpendicular to the axis of winding of the group of electrodes. Examples of the shape of the battery include a paper shape, a coin shape, a cylinder shape, and a rectangular shape.

### <Negative Electrode for Sodium Secondary Battery>

The negative electrode may be designed to be doped with sodium ions and dedoped from the sodium ions at a potential lower than that of the positive electrode. Examples of the negative electrode include an electrode formed by supporting a negative electrode mixture containing a negative electrode material on a negative electrode current collector, or an electrode comprised of solely a negative electrode material. Examples of the negative electrode material include materials which can be doped with sodium ions and dedoped from the sodium ions at a potential lower than that of the positive electrode, among materials selected from a carbonaceous material, a chalcogen compound (such as an oxide or a sulfide), a nitride, metal and an alloy. These negative electrode materials may be mixed and used.

With respect to the negative electrode material, the following materials are exemplified. Specific examples of the carbonaceous material include those materials which can be doped with sodium ions and dedoped from the sodium ions at a potential lower than that of the positive electrode, among graphites such as natural graphite and artificial graphite, cokes, carbon black, thermally decomposable carbons, carbon fibers and sintered organic polymeric materials. Two or more of these carbonaceous materials, oxides, sulfides and nitrides may be used in combination. These carbonaceous materials, oxides, sulfides and nitrides may be crystalline or amorphous. Each of these carbonaceous materials, oxides, sulfides and nitrides is mainly supported on a negative electrode current collector, and the resultant is used as an electrode.

Specific examples of the metals that can be doped with sodium ions and dedoped from the sodium ions at a potential lower than that of the positive electrode include sodium metal, silicon metal and tin metal. Specific examples of the alloy that can be doped with sodium ions and dedoped from the sodium ions at a potential lower than that of the positive electrode include sodium alloys such as Na—Al, Na—Ni and Na—Si, silicon alloys such as Si—Zn, tin alloys such as Sn—Mn, Sn—Co, Sn—Ni, Sn—Cu and Sn—La, and alloys such as Cu₂Sb and La₃Ni₂Sn₇. These metals and alloys are mainly used alone as an electrode (for example, as a foil).

Examples of the shape of the carbonaceous material include a flaky shape such as natural graphite, a spherical shape such as meso-carbon microbeads, a fiber shape such as graphitized carbon fibers, and an aggregate of fine powders.

The negative electrode mixture may contain a binder, if necessary. Examples of the binder include thermoplastic resins. Specific examples of the thermoplastic resin include PVDF, thermoplastic polyimide, carboxymethyl cellulose, polyethylene, and polypropylene. In the case where the electrolytic solution contains no ethylene carbonate to be described later, if a negative electrode mixture containing polyethylene carbonate is used, the resultant battery may have improved cycling characteristics and large-current discharging characteristics.

Examples of the negative electrode current collector include Cu, Ni, and stainless, and from the viewpoints of hardly forming an alloy with sodium and of being easily processed into a thin film, Cu is preferably used. Examples of a method of supporting the negative electrode mixture onto the negative electrode current collector include a pressure molding method; and a method in which a negative electrode mixture paste is obtained by further using a solvent or the like, and then the paste is applied to the negative electrode current collector, followed by drying, and the resultant sheet is pressed so that the negative electrode mixture is anchored to the current collector.

### <Separator for Sodium Secondary Battery>

Examples of the separator include members having modes such as a porous film, a nonwoven cloth, and a woven cloth, which are made from materials such as polyolefin resins including polyethylene and polypropylene, fluorine resins, and nitrogen-containing aromatic copolymers. The separator may be made from two or more kinds of the above-mentioned materials, or may be a laminate separator which has the above-mentioned members laminated to each other. Examples of the separator include those separators disclosed in, for example, JP2000-30686A and JP10-324758A. From the viewpoint of increasing the volume energy density of the battery with a reduction in inner resistance, the thickness of the separator is normally about 5 to 200 μm, and preferably about 5 to 40 μm. The separator is preferably made as thin as possible, as long as its mechanical strength is retained.

The separator preferably includes a porous film containing a thermoplastic resin. In a nonaqueous electrolyte secondary battery, the separator is disposed between the positive electrode and the negative electrode. The separator is preferably designed to have such a function that, when an abnormal current flows in a battery due to a short circuit or the like between positive and negative electrodes, it interrupts the current to prevent (shutdown) an excessive current from flowing therethrough. In this case, the shutdown is carried out by clogging the fine pores of the porous film in the separator when the temperature of the second battery exceeds the normally used temperature. The separator is preferably designed to be shutdown at a temperature as low as possible when the normally used temperature is exceeded. Moreover, the separator is also preferably designed such that even when, after the shutdown, the temperature inside the battery rises to a certain degree of high temperature, the shutdown state is maintained without being film-ruptured by the temperature. In other words, the separator preferably has a high heat resistant property. Examples of the separator include a porous film having a heat resistant material such as a laminate film which has a heat resistant porous layer and a porous film laminated to each other, and preferably a separator comprised of a laminate film which has a heat resistant porous layer containing a heat resistant resin and a porous film containing a thermoplastic resin laminated to each other. By using such a porous film containing a heat resistant material as the separator, the thermally rupturing temperature can be made higher. The heat resistant porous layers may be laminated to both surfaces of the porous film.

The following description will discuss a separator comprised of the laminate film which has the heat resistant porous layer and the porous film laminated to each other. The thickness of this separator is normally from 5 μm to 40 μm, and more preferably from 5 μm to 20 μm. Supposing that the thickness of the heat resistant porous layer is A (μm), and that the thickness of the porous film is B (μm), the value of A/B is preferably from 0.1 to 1. From the viewpoint of the ion permeability, the separator is preferably provided with a gas permeability measured by a Gurley method of 50 to 300 seconds/100 cc, and more preferably 50 to 200 seconds/100 cc. The rate of porosity of the separator is normally 30 to 80% by volume, and more preferably 40 to 70% by volume.

In the laminate film, the heat resistant porous layer preferably contains a heat resistant resin. In order to further improve the ion permeability, the thickness of the heat resistant porous layer is preferably made thinner, and specifically, it is preferably from 1 μm to 10 μm, more preferably from 1 μm to 5 μm, and particularly preferably 1 μm to 4 μm. The heat resistant porous layer has fine pores, and the size (diameter) of each pore is normally 3 μm or less, and preferably 1 μm or less. The heat resistant porous layer may contain a filler to be described later. The heat resistant porous layer may be formed from an inorganic powder.

Examples of the heat resistant resin contained in the heat resistant porous layer include polyamide, polyimide, polyamideimide, polycarbonate, polyacetal, polysulfone, polyphenylene sulfide, polyetherketone, aromatic polyester, polyether sulfone and polyether imide. From the viewpoint of further improving the heat resistant property, the heat resistant resin is preferably polyamide, polyimide, polyamideimide, polyether sulfone or polyether imide, and more preferably, polyamide, polyimide or polyamideimide, and still more preferably, the heat resistant resin is a nitrogen-containing aromatic polymer such as an aromatic polyamide (para-oriented aromatic polyamide, meta-oriented aromatic polyamide), an aromatic polyimide, or an aromatic polyamideimide, and especially preferably an aromatic polyamide. From the viewpoint of production, the heat resistant resin is particularly preferably a para-oriented aromatic polyamide (hereinafter, may be sometimes referred to as “para-aramide”). Moreover, examples of the heat resistant resin also include poly-4-methylpentene-1 and cyclic olefin-based polymers. By using these heat resistant resins, the heat resistant property of the laminate film, that is, the thermal film-rupturing temperature of the laminate film can be improved.

The thermal film-rupturing temperature of the laminate film depends on the kind of the heat resistant resin, and is selected and used in accordance with the application state and application purpose. In the case where the nitrogen-containing aromatic polymer is used as the heat resistant resin, the thermal film-rupturing temperature can be controlled to about 400° C., in the case where poly-4-methylpentene-1 is used, it can be controlled to about 250° C., and in the case where a cyclic olefin-based polymer is used, it can be controlled to about 300° C., respectively. In the case where the heat resistant porous layer is made from an inorganic powder, the thermal film-rupturing temperature can be controlled to, for example, 500° C. or more.

The para-amide can be obtained by condensation polymerization between a para-oriented aromatic diamine and a para-oriented aromatic dicarboxylic acid halide, and its amide bonds are virtually composed of repeating units bonded at the para position or corresponding oriented position of an aromatic ring (for example, an oriented position extending coaxially in the opposite direction or in parallel therewith, such as 4,4′-biphenylene, 1,5-naphthalene, and 2,6-naphthalene). Specific examples of the para-amide include para-aramides having a para-oriented structure or a structure corresponding to the para-oriented type such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6 naphthalene dicarboxylic acid amide), poly(2-chloro-paraphenylene terephthalamide), and paraphenylene terephthalamide/2,6-dichloroparaphenylene terephthalamide copolymers.

The aromatic polyimide is preferably a total aromatic polyimide produced by condensation polymerization between an aromatic dianhydride and a diamine. Specific examples of the dianhydride include pyromellitic dianhydride, 3,3′,4,4′-diphenylsulfonetetracarboxylic dianhydride, 3,3′,4,4′-benzophenonetetracarboxylic dianhydride, 2,2′-bis(3,4-dicarboxyphenyl)hexafluoropropane and 3,3′,4,4′-biphenyltetracarboxylic dianhydride. Examples of the diamine include oxydianiline, paraphenylene diamine, benzophenone diamine, 3,3′-methylene dianiline, 3,3′-diaminobenzophenone, 3,3′-diaminodiphenyl sulfone and 1,5-naphthalene diamine. A polyimide that is soluble to a solvent is desirably used. Examples of the polyimide include polyimides of polycondensation products between 3,3′,4,4′-diphenylsulfonetetracarboxylic dianhydride and an aromatic diamine.

Examples of the aromatic polyamideimide include a condensation polymerization product between an aromatic dicarboxylic acid and an aromatic diisocyanate, and a condensation polymerization product between an aromatic dianhydride and an aromatic diisocyanate. Specific examples of the aromatic dicarboxylic acid include isophthalic acid and terephthalic acid. Specific examples of the aromatic dianhydride include trimellitic anhydride. Specific examples of the aromatic diisocyanate include 4,4′-diphenylmethane diisocyanate, 2,4-tolylene diisocyanate, 2,6-tolylene diisocyanate, ortho-tolylene diisocyanate, and m-xylene diisocyanate.

In the case where the heat resistant porous layer contains a heat resistant resin, the heat resistant porous layer may contain one or more kinds of fillers. Examples of the filler include an organic powder, an inorganic powder, and a mixture of these. Particles forming the filler preferably have an average particle diameter of from 0.01 μm to 1 μm. Examples of the filler shape include a virtually spherical shape, a plate shape, a pillar shape, a needle shape, a whisker shape, and a fiber shape, and from the viewpoint of easily forming uniform pores, virtually spherical particles are preferable. Examples of the virtually spherical particles include particles having an aspect ratio (major axis of particles/minor axis of particles) of particles of from 1 to 1.5. The aspect ratio of the particles can be measured by using an electron microscope photograph.

Examples of the organic powder for use as the filler include powders made from organic substances such as a single material or a copolymer of two or more kinds of materials including styrene, vinyl ketone, acrylonitrile, methyl methacrylate, ethyl methacrylate, glycidyl methacrylate, glycidyl acrylate and methylacrylate; fluorine resins such as polytetrafluoroethylene, a tetrafluoroethylene-hexafluoropropylene copolymer, a tetrafluoroethylene-ethylene copolymer, and polyvinylidene fluoride; melamine resins; urea resins; polyolefins; and polymethacrylates. Each of these organic powders may be used solely, or two or more kinds thereof may be mixed and used. Among these organic powders, from the viewpoint of chemical stability, a polytetrafluoroethylene powder is preferably used.

Examples of the inorganic powder for use as the filler include powders made from inorganic substances such as metal oxides, metal nitrides, metal carbides, metal hydroxides, carbonates, and sulfates. Among these, powders made from inorganic substances having low conductivity are preferably used. Specific examples of the inorganic powders include powders made from one or more kinds of compounds selected from the group consisting of alumina, silica, titanium dioxide, barium sulfate, and calcium carbonate. Each of these inorganic powders may be used solely, or two or more kinds thereof may be mixed and used. Among these inorganic powders, from the viewpoint of chemical stability, an alumina powder is preferably used. More preferably, all the particles forming the filler are alumina particles, and furthermore preferably, all the particles forming the filler are alumina particles, with a portion or all of the alumina particles being formed into virtually spherical shapes. In the case where the heat resistant porous layer is made from inorganic powder, the above-exemplified inorganic powder may be used, and may also be mixed with a binder, if necessary, and used.

In the case where the heat resistant porous layer contains a heat resistant resin, the content of the filler is dependent on the specific gravity of the filler material. For example, when all the particles forming the filler are made of alumina particles, the weight ratio of the filler is normally from 5 to 95, preferably from 20 to 95, and more preferably from 30 to 90 per total weight 100 of the heat resistant porous layer. These ranges can be appropriately determined depending on the specific gravity of the filler material.

The porous film in the laminate film has fine pores. The porous film preferably has a shut down function. Therefore, the porous film preferably contains a thermoplastic resin. The thickness of the porous film is normally 3 to 30 μm, and preferably 3 to 25 μm. In the same manner as in the heat resistant porous layer, the porous film contains fine pores, and the size of each pore is normally 3 μm or less, and preferably 1 μm or less. The rate of porosity of the porous film is normally 30 to 80% by volume, and preferably 40 to 70% by volume. In the case where a secondary battery is used at a temperature exceeding the normally used temperature, the separator is allowed to exert the shut down function of the porous film, that is, to clog the fine pores by softening the thermoplastic resin forming the porous film.

Examples of the thermoplastic resin to be contained in the porous film include resins that soften at 80 to 180° C. A resin that is not dissolved in an electrolytic solution in the secondary battery may be selected. Examples of the thermoplastic resin include polyolefin resins such as polyethylene and polypropylene, and a thermoplastic polyurethane resin, and two or more kinds of the thermoplastic resins may be mixed and used. In order to cause shut down at a lower temperature, the thermoplastic resin preferably contains polyethylene. Specific examples of the polyethylene include a low-density polyethylene, a high-density polyethylene and a linear polyethylene, and an ultra-high molecular weight polyethylene having a molecular weight of 1,000,000 or more. In order to further increase the sticking-resistant strength of the porous film, the porous film preferably contains an ultra-high molecular weight polyethylene. In order to easily produce the porous film, the porous film may be preferably allowed to contain a wax made from polyolefin having a low molecular weight (weight average molecular weight of 10,000 or less) in some cases.

Examples of the porous film having a heat resistant material include a porous film made from a heat resistant resin or an inorganic powder or both, and a porous film in which the heat resistant resin or inorganic powder or both are dispersed in a thermoplastic resin film such as a polyolefin resin, a thermoplastic resin, or the like. Examples of the heat resistant resin and the inorganic powder include those described above.

An electrolytic solution normally contains an electrolyte and an organic solvent. Examples of the electrolyte include sodium salts such as NaClO₄, NaPF₆, NaAsF₆, NaSbF₆, NaBF₄, NaCF₃SO₃, NaN(SO₂CF₃)₂, NaN(SO₂C₂F₅)₂, NaN(SO₂CF₃) (COCF₃) Na(C₄F₉SO₃) NaC(SO₂CF₃)₃, NaBPh₄, Na₂B₁₀Cl₁₀, NaBOB (in this case, BOB represents bis(oxalato)borate), sodium salts of lower aliphatic carboxylic acid and NaAlCl₄, and two or more kinds of these electrolytes may be mixed and used. Among these, one or more fluorine-containing sodium salts selected from the group consisting of NaPF₆, NaAsF₆, NaSbF₆, NaBF₄, NaCF₃SO₃, NaN(SO₂CF₃)₂ and NaC(SO₂CF₃)₃ are preferably used.

Examples of the organic solvent in the electrolytic solution include carbonates such as propylene carbonate (hereinafter, may be sometimes referred to as PC), ethylene carbonate (hereinafter, may be sometimes referred to as EC), dimethyl carbonate (hereinafter, may be sometimes referred to as DMC), diethyl carbonate, vinylene carbonate, isopropylmethyl carbonate, propylmethyl carbonate, ethylmethyl carbonate (hereinafter, may be sometimes referred to as EMC), 4-trifluoromethyl-1,3-dioxolan-2-one and 1,2-di(methoxycarbonyloxy)ethane; ethers such as 1,2-dimethoxyethane, 1,3-dimethoxypropane, pentafluoropropyl methylether, 2,2,3,3-tetrafluoropropyl difluoromethylether, tetrahydrofuran and 2-methyl tetrahydrofuran; esters such as methyl formate, methyl acetate and γ-butyrolactone; nitriles such as acetonitrile and butyronitrile; amides such as N,N-dimethylformamide and N,N-dimethylacetoamide; carbamates such as 3-methyl-2-oxazolidone; sulfur-containing compounds such as sulforan, dimethylsulfoxide and 1,3-propane sultone, and those solvents formed by further introducing a fluorine substituent to the above-mentioned organic solvents. A mixed solvent which contains two or more kinds of these solvents may be used.

In place of the electrolytic solution, a solid-state electrolyte may be used. As the solid-state electrolyte, for example, organic solid-state electrolytes such as a polyethylene oxide-based polymer or a polymer containing at least one kind of a polyorgano siloxane chain and a polyoxyalkylene chain may be used. A so-called gel-type electrolyte formed by allowing a polymer to support an electrolytic solution may also be used. An inorganic solid-state electrolyte such as Na₂S—SiS₂, Na₂S—GeS₂, Na₂S—P₂S₅, Na₂S—B₂S₃, Na₂S—SiS₂—Na₃PO₄ or Na₂S—SiS₂—Na₂SO₄ may be used. Examples of the inorganic solid-state electrolyte include NASICON-type electrolytes such as NaZr₂(PO₄)₃. By using these solid-state electrolytes, high safety may be further ensured. In the sodium secondary battery, in the case of using the solid-state electrolyte, the solid-state electrolyte may serve as a separator in some cases, and in this case, no separator may be required in some cases.

### EXAMPLES

The following description will further discuss the present invention in detail by means of examples. However, the present invention is not intended to be limited thereto.

### Example 1

### Generation of Liquid-Like Material

Sodium hydroxide (NaOH) serving as a raw material of Na, a ferric chloride (II) tetrahydrate (FeCl₂.4H₂O) serving as a raw material of Fe and phosphoric acid (H₃PO₄) serving as a raw material of P were precisely weighed so as to have a molar ratio of sodium (Na): iron (Fe): phosphorus (P) of 3:1:1, and the respective compounds thus precisely weighed were put into glass beakers of 100 ml, and ion-exchange water was added to the respective beakers so that respective aqueous solutions were obtained. Next, the aqueous sodium hydroxide solution and the aqueous phosphoric acid solution were mixed with each other while being stirred, and to this was further added an aqueous solution in which the ferric chloride (II) tetrahydrate had been dissolved so that a liquid-like material was obtained.

### <Generation and Collection of Precipitate of Electrode Active Material>

The resultant liquid-like material was put into an egg plant flask, and then the egg plant flask was heated for 20 minutes in an oil bath set at 150° C. so that a precipitate was obtained. This precipitate was washed with water, and filtered so that the precipitate was collected. One portion of the precipitate was taken out, and dried at 100° C. for 3 hours. From a weight change before and after the drying, the amount of moisture in the precipitate was found to be 45% by weight.

One portion of the collected precipitate was dried at 100° C. for 3 hours, and when the resultant powder was measured by an X-ray diffractometry, it was found that a single-phase NaFePO₄ was formed and an electrode active material was obtained.

### <Production of Aqueous Binder>

In 25 parts by weight of water were dissolved 0.7 parts by weight of sodium dodecylbenzene sulfonate, 0.005 parts by weight of ferrous sulfate and 0.8 parts by weight of sodium hydrogencarbonate. The resultant solution was sent to a polymerization vessel preliminarily purged with ethylene, and to this was added 2 parts by weight of vinyl chloride, and after these components had been stirred and emulsified, the inner pressure of the polymerization vessel was raised to 4.9 MPa by introducing an ethylene gas, and the inner vessel temperature was raised to 50° C. While the temperature was maintained at 50° C., polymerization was performed over 8 hours, with 18 parts by weight of vinyl chloride, 1.5 parts by weight of a Rongalite aqueous solution and 8.0 parts by weight of an aqueous ammonium persulfate solution being continuously added thereto, and the excessive ethylene was then discharged down to the atmospheric pressure so that an ethylene-vinyl chloride copolymer resin emulsion (aqueous emulsion) having 50% by weight of copolymer components was obtained.

### <Production of Electrode Paste>

The collected precipitate of electrode active material NaFePO₄ (85 parts by weight) and 10 parts by weight of acetylene black serving as an electrical conductive material were sufficiently mixed with each other in a mortar, and to this mixture were then added 2% by weight of an aqueous carboxyl methylcellulose (CMC) solution (330 parts by weight) serving as a viscosity improver and the ethylene-vinyl chloride copolymer resin emulsion (aqueous emulsion) serving as a binder so as to have nonvolatile components of 0.7 parts by weight, and these components were mixed and dispersed by a Dispermat to obtain an electrode paste.

### <Formation of Applied Film>

The resultant electrode paste was applied to an aluminum foil of 40 μm by using a film applicator so that an applied film was obtained.

### <Production of Electrode>

The applied film was dried in a hot-air dryer, and rolled by a press roller, and punched out into a round shape with a size of 14.5 mm φ so that electrodes were manufactured.

### <Production of Sodium Secondary Battery>

The electrode thus obtained was used as a positive electrode. As a separator, a polypropylene porous film (thickness: 20 μm) was used. As a solvent for an electrolytic solution, PC was used. As an electrolyte, NaClO₄ was used. The electrolyte was dissolved in the solvent at a rate of 1 mole/liter so that an electrolytic solution 1 was prepared. Metal sodium was used as a negative electrode. The positive electrode was placed on a concave portion of the lower part of a coin cell (manufactured by Hohsen Corporation) with its aluminum foil surface facing down, and the separator was placed thereon, and then the electrolytic solution 1 was injected thereto. Next, the negative electrode and a middle lid were combined with each other and these were placed on the upper side of the separator with the negative electrode facing down, and the upper part was put thereon as a lid with a gasket interpolated therebetween, and the lid was caulked by using a caulking machine, so that a sodium secondary battery (coin-shaped battery R2032) was manufactured. The assembling processes of the battery were carried out in a glove box in an argon atmosphere.

### <Evaluation of Secondary Battery>

Charging/discharging tests were carried on the secondary battery while being kept at 25° C., under the following conditions.

### <Charging/Discharging Tests>

Charging: Charging maximum voltage 4.2 V, Constant current charging, 0.1C rate (Charging time: 10 hours)
Discharging: Discharging minimum voltage 1.5 V, Constant current discharging, 0.1C rate (1.5 V cutoff)
Number of charging/discharging times (cycle times): 10 times
Discharging capacity retaining rate: Discharging capacity at each cycle/Discharging capacity at one cycle×100

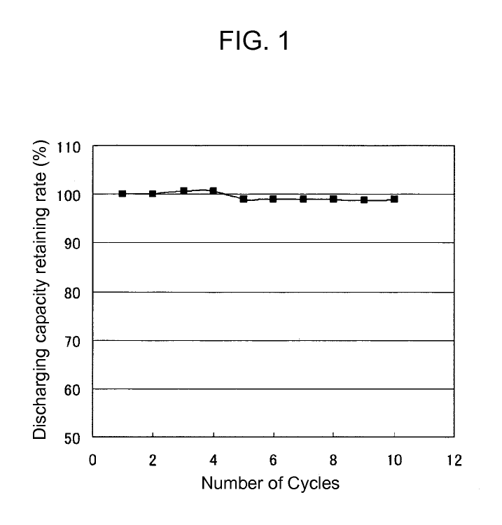

The results of the charging/discharging tests are shown in FIG. 1. From the results shown in FIG. 1, it was confirmed that the discharging capacity retaining rate was hardly changed.

Even in the case where an electrode paste in which one portion or all portion of Fe in the example was substituted with Mn was produced, and tested, the same effects as those described above were obtained. It is found that the sodium secondary battery in the present invention was sufficiently superior in secondary battery characteristics such as charging/discharging cycle characteristics. Therefore, it is found that in accordance with the present invention, an electrode and an electrode paste can be easily obtained without requiring hydrothermal synthesis, and that even when sodium, which is abundant in resources and inexpensive, is used, a secondary battery that is sufficiently superior in secondary battery characteristics can be obtained.

### Reference Example 1

A precipitate was obtained in the same manner as in Example 1 except that Li was used in place of Na, with LiOH being used as a raw material of Li. One portion of the precipitate was taken out, and dried at 100° C. for 3 hours. From a weight change before and after the drying, the amount of moisture in the precipitate was found to be 30% by weight.

One portion of the collected precipitate was dried at 100° C. for 3 hours, and when the resultant powder was measured by an X-ray diffractometry, a peak belonging to LiFePO₄ was observed; however, other phases of impurities were also observed.

Next, 85 parts by weight of the collected precipitate and 10 parts by weight of acetylene black serving as an electrical conductive material were sufficiently mixed with each other in a mortar, and to this mixture were then added 2% by weight of an aqueous carboxyl methylcellulose (CMC) solution (330 parts by weight) serving as a viscosity improver and the ethylene-vinyl chloride copolymer resin emulsion (aqueous emulsion) serving as a binder so as to have nonvolatile components of 0.7 parts by weight, and these components were mixed and dispersed by a Dispermat to obtain an electrode paste. The resultant electrode paste was applied to an aluminum foil of 40 μm by using a film applicator so that an applied film was obtained. The applied film was dried in a hot-air dryer, and rolled by a press roller, and punched out into a round shape with a size of 14.5 mm φ so that electrodes were manufactured.

The electrode thus obtained was used as a positive electrode. As a separator, a polypropylene porous film (thickness: 20 μm) was used. As a solvent for an electrolytic solution, a mixed solvent of EC:DMC:EMC=30:35:35 (volume ratio) was used. As an electrolyte, LiPF₆ was used. The electrolyte was dissolved in the mixed solvent at a rate of 1 mole/liter so that an electrolytic solution 2 was prepared. Metal lithium was used as a negative electrode. The positive electrode was placed on a concave portion of the lower part of a coin cell (manufactured by Hohsen Corporation) with its aluminum foil surface facing down, and the separator was placed thereon, and then the electrolytic solution 2 was injected thereto. Next, the negative electrode and a middle lid were combined with each other and these were placed on the upper side of the separator with the negative electrode facing down, and the upper part was put thereon as a lid with a gasket interpolated therebetween, and the lid was caulked by using a caulking machine, so that a lithium secondary battery (coin-shaped battery R2032) was manufactured. The assembling processes of the battery were carried out in a glove box in an argon atmosphere.

The charging/discharging tests were performed on the resultant coin-shaped battery in the same manner as in Example 1; however, the charging/discharging was available only up to 7 cycles.

### Production Example 1

### Production of Laminate Film

### (1) Production of Coating Solution

After 272.7 g of calcium chloride had been dissolved in 4200 g of NMP, to this was added 132.9 g of paraphenylene diamine and completely dissolved therein. To the resultant solution was gradually added 243.3 g of terephthaloyl dichloride to be polymerized so that para-aramide was obtained, and this was further diluted with NMP so that a para-aramide solution (A) having a concentration of 2.0% by weight was obtained. To the resultant para-aramide solution (100 g) were added 2 g of an alumina powder (a) (alumina C, manufactured by Japan Aerosil Inc., average particle diameter: 0.02 μm) and 2 g of an alumina powder (b) (Sumicorundum AA03, manufactured by Sumitomo Chemical Co., Ltd., average particle diameter: 0.3 μm), that is, the total of 4 g, and mixed therein as fillers, and this was processed by a nanomizer three times, and further filtered by a wire gauze with 1000 meshes, and then defoamed under reduced pressure so that a slurry coating solution (B) was produced. The weight of the alumina powder (filler) relative to the total weight of the paraamide and the alumina powder was 67% by weight.

### (2) Production and Evaluations of Laminate Film

As a porous film, a polyethylene porous film (film thickness: 12 μm, gas permeability: 140 seconds/100 cc, average pore diameter: 0.1 μm, rate of porosity: 50%) was used. The polyethylene porous film was secured onto a PET film having a thickness of 100 μm, and the slurry coating solution (B) was applied onto the porous film by using a bar coater manufactured by Tester Sangyo Co., Ltd. The PET film and the applied porous film were immersed into water as a poor solvent while being integrally kept so that a para-aramide porous film (heat resistant layer) was deposited thereon, and the solvent was then dried so that a laminate film 1 having the heat resistant porous layer and the porous film stacked thereon was obtained. The laminate film 1 had a thickness of 16 μm, and the paraamide porous film (heat resistant porous layer) had a thickness of 4 μm. The laminate film 1 had a gas permeability of 180 seconds/100 cc, and a rate of porosity of 50%. When the cross section of the heat resistant porous layer in the laminate film 1 was observed by a scanning electron microscope (SEM), it was found that comparatively small fine pores in a range from about 0.03 μm to 0.06 μm and comparatively large fine pores in a range from about 0.1 μm to 1 μm were present. The evaluations on the laminate film were carried out by the following method.

### <Evaluation of Laminate Film>

### (A) Thickness Measurements

The thickness of the laminate film and the thickness of the porous film were measured in accordance with JIS Standard (K7130-1992). Moreover, a value obtained by subtracting the thickness of the porous film from the thickness of the laminate film was used as the thickness of the heat resistant porous layer.

### (B) Measurements of Gas Permeability by Gurley Method

The gas permeability of the laminate film was measured in accordance with JIS P8117 by using a digital timer-type Gurley type Densometer manufactured by Yasuda Seiki Seisakusho Ltd.

### (C) Rate of Porosity

The sample of the resultant laminate film was cut out into a square having a length of 10 cm in each side, and the weight W (g) and the thickness D (cm) were measured. The weights of the respective layers in the sample (Wi(g); i is an integer from 1 to n) were obtained, and based on Wi and the true specific gravity (true specific gravity i (g/cm³)) of the material of each layer, the volume of each of the layers was obtained, and the rate of porosity (% by volume) was calculated from the following expression:

Rate of porosity (% by volume)=100×{1−(W1/True Specific Gravity 1+W2/True Specific Gravity 2+ . . . +Wn/True Specific Gravity n)/(10×10×D)}

In the examples, by using the laminate film obtained from Production Example 1, a sodium secondary battery capable of increasing the thermal film-rupturing temperature can be obtained.

### INDUSTRIAL APPLICABILITY

The present invention makes it possible to provide a method for easily producing an electrode and an electrode paste by using sodium, and a sodium secondary battery using the electrode. The present invention can produce the electrode and the electrode paste easily without requiring hydrothermal synthesis. Since the sodium secondary battery of the present invention utilizes sodium that is abundant in resources and inexpensive in comparison with lithium as its electrode, it becomes possible to produce a large number of large-sized secondary batteries, such as secondary batteries for use in automobiles and secondary batteries for use in dispersion-type power storage. The sodium secondary battery of the present is also superior in secondary battery characteristics such as charging/discharging characteristics. Therefore, the present invention is very useful from the industrial point of view.

1. A method for producing an electrode comprising the following steps (1) to (5) in this order:
(1) a step of bringing a raw material of P (phosphorus), a raw material of A (wherein A represents one or more elements selected from the group consisting of alkali metal elements A comprises Na), a raw material of M (wherein M represents one or more elements selected from the group consisting of transition metal elements), and water into contact with each other and generating a liquid-like material thereby,
(2) a step of heating the liquid-like material and generating a precipitate of an electrode active material thereby, and then collecting the precipitate by solid-liquid separation,
(3) a step of mixing the collected precipitate and a binder and producing an electrode paste thereby,
(4) a step of applying the electrode paste on a current collector and forming an applied film thereby, and
(5) a step of drying the applied film and producing an electrode thereby.

2. The method according to claim 1, wherein the heating in the step (2) is performed under the pressure of from 0.01 MPa to 0.5 MPa.

3. The method according to claim 1, wherein any one of steps (1) to (3) further comprises mixing of an electrical conductive material.

4. The method according to claim 1, wherein the step (3) further comprises mixing of a viscosity improver.

5. The method according to claim 1, wherein the electrode active material is represented by the following formula (I):
AMPO₄ (I)
wherein A and M each have the same meaning as defined above.

6. The method according to claim 1, wherein M comprises a divalent transition metal element.

7. The method according to claim 1, wherein M comprises Fe or Mn or both.

8. The method according to claim 1, wherein A is Na.

9. The method according to claim 1, wherein the binder is an aqueous binder.

10. The method according to claim 4, wherein the viscosity improver is an aqueous viscosity improver.

11. A sodium secondary battery comprising an electrode produced by the method according to claim 1 as a positive electrode.

12. A method for producing an electrode paste comprising the following steps (11) to (13) in this order:
(11) a step of bringing a raw material of P (phosphorus), a raw material of A (wherein A represents one or more elements selected from the group consisting of alkali metal elements and A comprises Na), a raw material of M (wherein M represents one or more elements selected from the group consisting of transition metal elements), and water into contact with each other and generating a liquid-like material thereby,
(12) a step of heating the liquid-like material and generating a precipitate of an electrode active material thereby, and then collecting the precipitate by solid-liquid separation, and
(13) a step of mixing the collected precipitate and a binder and producing an electrode paste thereby.

13. The method according to claim 12, wherein any one of steps (11) to (13) further comprises mixing of an electrical conductive material.

14. The method according to claim 12, wherein the step (13) further comprises mixing of an aqueous viscosity improver.

15. An electrode paste produced by the method according to claim 12.
